(19) United States
(12) Patent Application Publication
(10) Pub. No.: US 2012/0237147 A1
(43) Pub. Date: Sep. 20, 2012

(54) Integrated ball cage

(75) Inventor: Hubert Utz, Alling (DE)

(73) Assignees: Digital Imaging Systems GmbH; .

(21) Appl. No.: 13/065,278

(22) Filed: Mar. 18, 2011

(51) Int. Cl. F16C 29/04

(52) U.S. Cl. 384/49

(57) ABSTRACT

Systems and methods to reduce manufacturing and assembly costs for measures to avoid blocking or creeping ball conditions for linear ball bearings are disclosed. In preferred embodiments two linear ball bearings, a fixed ball bearing and a non-locating ball bearing, are applied to guide movements of a lens barrel of camera modules. Ball cages, which are integrated either in a moving part or in a fixed part of an actuator, are lowering manufacturing and assembly costs. A constant magnetic preload force is applied to both ball bearings to keep the bearings together in case of a mechanic shock. Ball bearing contact points of the fixed ball bearing are shifted asymmetrically by a small angle to withstand horizontal preload forces.

### RELATED APPLICATIONS

This application is related to the following US patent applications:

DI09-003/004, titled “Camera Module having a low-friction movable lens”, Ser. No. 12/661,752, filing date Mar. 23, 2010,

DI10-001, titled “Camera Shutter System”, Ser. No. ______, filing date ______, and

DI10-005, Ser. No. 12/806,322 titled “Single actuator configuration for a camera module”, serial number, filing date Aug. 10, 2010,

and the above applications are herein incorporated by reference in their entirety.

### BACKGROUND OF THE INVENTION

(1) Field of the Invention

This invention relates generally to a ball bearing actuator system for camera modules and relates more specifically to integrated ball cages for linear ball bearings used.

(2) Description of the Prior Art

For a linear ball bearing system it is important to ensure that each individual ball can roll under all conditions and is not blocked. If a ball is blocked at the end of a ball cavity, additional force is required to overcome the friction of a gliding ball. FIG. 1 prior art shows an example of an application of a linear ball bearing, namely moving a lens barrel of a camera module such as disclosed in the patent application DI10-001, titled “Camera Shutter System” Ser. No. ______, filing date ______. The movements of a lens barrel 4 are guided by balls 1 of a linear ball bearing. Each ball 1 moves in a correspondent cavity 3 of the lens barrel 4 between a fixed carrier 2 and the movable lens barrel.

For a linear ball bearing system it is important to ensure that each individual ball can roll under all conditions and is not blocked. If a ball is blocked at the end of a ball cavity, additional force is required to overcome the friction of a gliding ball.

The lower ball of FIG. 1 prior art is touching the end of its cavity. If the lens 4 is moved upwards, the lower ball cannot roll and needs to glide. In order to prevent blocking ball conditions ball cages and a bearing pin have been disclosed in the patent application DI09-003004, titled “Camera Module having a low-friction movable lens” Ser. No. 12/661,752, filing date Mar. 23, 2010, which is herein incorporated by reference in their entirety.

It is a challenge for engineers to find solutions to avoid blocking ball conditions while reducing manufacturing and assembly costs as much as possible.

There are known patents or patent publications dealing with linear ball bearings and guiding of lens barrels of camera modules.

U.S. Patent Publication (US 2010/0091392 to Jung et al.) teaches a lens driving unit that generates a precise linear motion in a spatially limited structure by using a bending vibration piezoelectric motor having a new structure, and a camera module comprising the lens driving unit. The lens driving unit includes: a lens carrier supporting a lens and comprising a guide axis exposed at least partially to the outside and extending in a direction substantially perpendicular to the lens; and a piezoelectric driving unit having a center portion contacting the guide axis according to a bending motion of a piezoelectric element and moving the lens carrier in a direction in which the guide axis extends.

U.S. Patent (U.S. Pat. No. 7,611,285 to Rudy et al.) discloses a linear ball bearing having a guide carriage, which is guided on a guide rail in a longitudinally displaceable manner and is mounted in rolling contact on longitudinal sides of the guide rail via balls which are arranged on each longitudinal side in at least two parallel ball rows encircling in endless ball channels, each ball of the one ball row together with an adjacent ball of the other ball row being held all round in cage pockets of a common cage piece, the cage piece having exactly two cage pockets for one ball each from both ball rows, each cage piece, as viewed in the running direction of the balls, being provided at both ends with convexly curved end surfaces for contact with the end surfaces of adjacent cage pieces, which end surfaces extend essentially up to the cage piece sides.

U.S. Patent (U.S. Pat. No. 7,643,740 to Lee) discloses a handshake correction module for a digital camera, which has a small volume and small operational load when moved. The hand-shake correction module includes a base plate; a first sliding member which moves in a first axis direction with respect to the base plate; a second sliding member including an image pickup device, the second sliding member being movable with respect to the first sliding member in a second axis direction perpendicular to the first axis; and a pressing means which generates a magnetic force preventing the first sliding member and the second sliding member from being separated from the base plate.

### SUMMARY OF THE INVENTION

A principal object of the present invention is to achieve methods and systems to reduce manufacturing and assembly costs for measures to avoid blocking ball conditions for linear ball bearings.

A further objective of the invention is to avoid creeping of balls of ball bearings.

A further object of the invention is to keep balls of a linear ball bearing in place in case of a mechanical shock.

A further object of the present invention is to minimize friction of movements of a lens barrel.

A further objective of the invention is to utilize folded bit line or segment-to-segment folded bit line scheme.

In accordance with the objects of this invention a method to reduce manufacturing and assembly costs for measures to avoid blocking ball conditions for linear ball bearings has been achieved. The method comprises the following steps, firstly: (1) providing a camera module wherein movements of a lens barrel are driven by at least one linear actuator and are guided by a first and a second ball bearing, (2) inserting each ball of the ball bearings in an own integrated ball cage, which is integrated in the moving lens barrel, and (3) selecting for the first ball bearing a fixed ball bearing, wherein ball bearing contact points are shifted by a small angle in direction of a preload force applied to the first ball bearing. Furthermore the method comprises (4) selecting for the second ball bearing a non-locating ball bearing, (5) deploying each ball bearing in a suitable position in order to be able to receive the preload force, and (6) providing the preload force towards the bearings in order to hold the bearings together in case of a mechanical shock and to have the balls always touching their surface to roll on.

In accordance with the objects of this invention an arrangement of ball bearings preventing blocking and creeping of balls for guiding movements of a lens barrel has been achieved. The arrangement of ball bearings comprises: a fixed ball bearing, wherein ball bearing contact points are shifted by a small angle in direction of a constant preload force applied and each ball of the fixed ball bearing rolls in an own integrated ball cage, which is integrated in the moving lens barrel, a non-locating ball bearing, wherein each ball of the non-locating ball bearing rolls in an own integrated ball cage, which is integrated in the moving lens barrel, and a magnetic pre-load device providing a constant pre-load force on the fixed ball bearing and on the non-locating ball bearing in order to hold the bearings together in case of a mechanical shock and to have the balls always touching their surface to roll on.

### BRIEF DESCRIPTION OF THE DRAWINGS

In the accompanying drawings forming a material part of this description, there is shown:

FIG. 1 prior art shows an example of an application of a linear ball bearing, namely moving a lens barrel of a camera module.

FIG. 2 illustrates an example of a principle of a ball fixture that is used by the invention in an innovative, modified way.

FIG. 3a depicts a top view of a fixed bearing invented showing a fixed part of the actuator and a moving part.

FIG. 3b shows a non-locating bearing to achieve a statically defined bearing system.

FIG. 4a depicts the surface of the fixed bearing constructed out of a V-shape.

FIG. 4b illustrates integrated ball cages and two balls moving around their ball bearing contact points.

FIG. 5 shows a preferred embodiment of a deployment of the non-locating bearing and of a fixed ball bearing applied to a camera module.

FIG. 6 shows the main force vectors caused by the magnetic preload acting on both non-locating ball bearing and fixed ball bearing applied to the camera module.

FIG. 7 illustrates the different components of the main force vectors of FIG. 6

FIG. 8 illustrates a flowchart of a method invented to reduce manufacturing and assembly costs for measures to avoid blocking ball conditions for linear ball bearings.

### DESCRIPTION OF THE PREFERRED EMBODIMENTS

Preferred embodiments of methods and systems to reduce manufacturing and assembly costs for measures to avoid blocking ball conditions for linear ball bearings using an integrated ball cage are disclosed. Furthermore the invention ensures that balls of the linear ball bearing are kept in place in case of a mechanical shock and that movements of the movable part of linear bearing, such as e.g. a lens barrel of a camera module, can be performed with minimal friction. The present invention could also be used for other applications where ball bearing with just one rotational plane can be used.

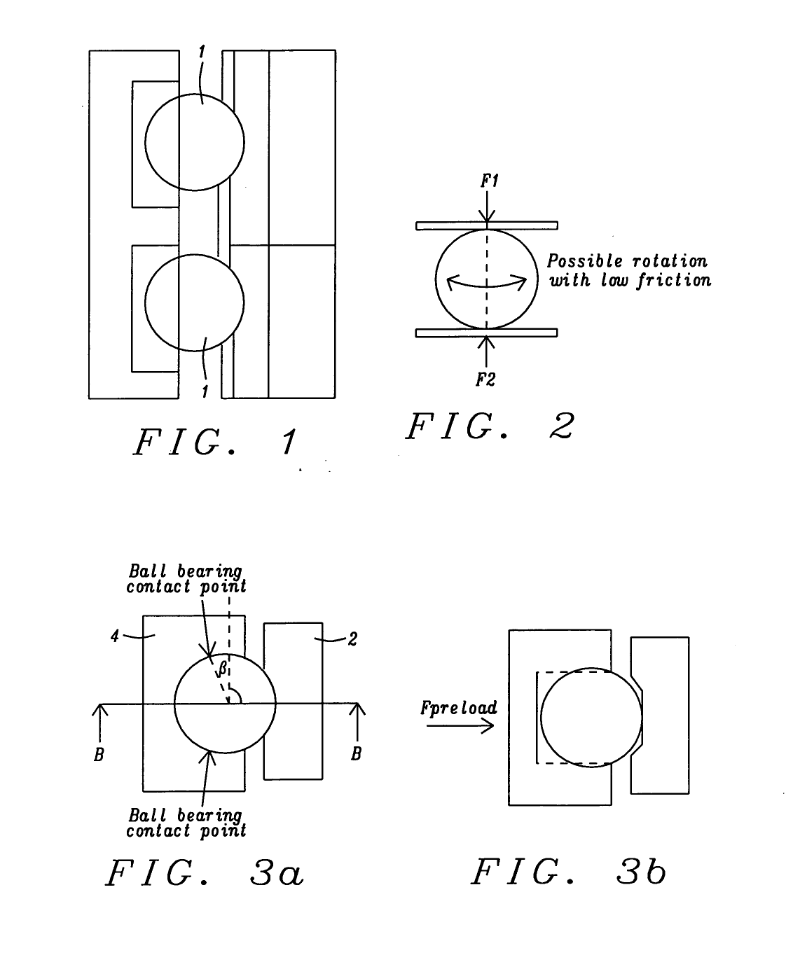

A preferred embodiment of the invention comprises a linear bearing of a lens barrel using an integrated ball cage. The invention can be applied to other applications requiring small and precise movements. FIG. 2 illustrates an example of a principle of a ball fixture that is used by the invention in an innovative modified way.

The ball of FIG. 2 is fixed at the two poles F1 and F2 of the ball axes, hence the ball can only roll along one rotational plane with low friction, in this case along the equator as indicated by a double arrow in FIG. 2.

A preferred embodiment of the invention has four balls inserted in the moving part of an actuator without using an external ball cage and a holding pin. It should be noted that the balls could be inserted into the fixed part of the camera module as well. Another number of balls could also be used.

For the assembly process it is desired to insert the balls outside of the module housing of the camera module. In this case either a lens barrel holder or a customized lens barrel are to be used for that.

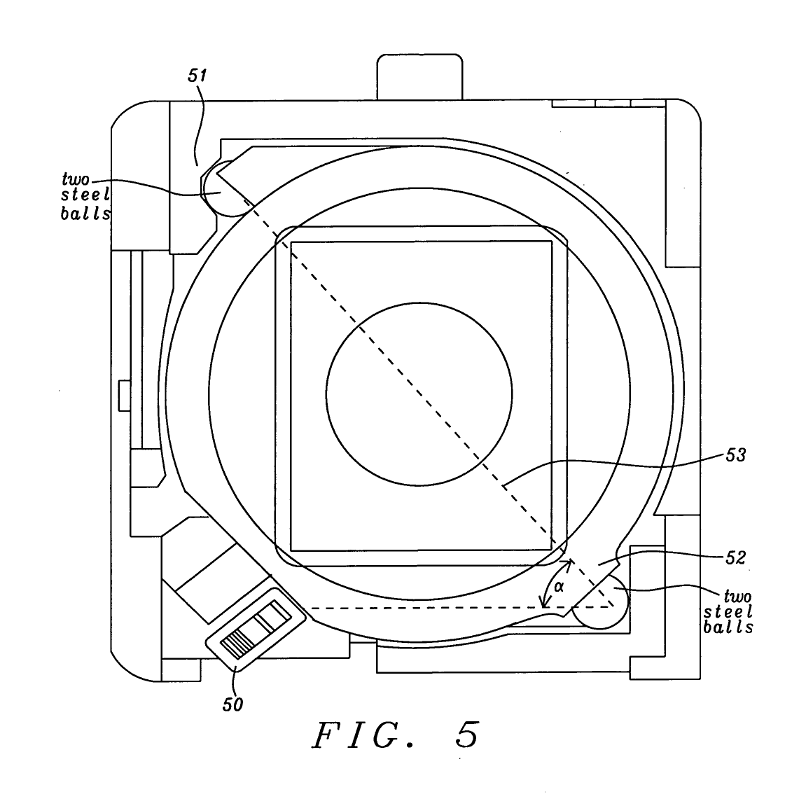

The ball fixture principle as outlined above in regard of FIG. 2 is not able to take horizontal forces. As the application requires withstanding horizontal forces (Preload) to the bearing the poles are shifted asymmetrically by a small angle β (e.g. 10 degrees) to be able to absorb horizontal forces as shown in FIG. 3a. Other angles in the order of 10 degrees are also possible.

FIG. 3a depicts a top view of a fixed bearing invented showing a fixed part 2 of the actuator and a moving part 4. In FIG. 3a the moving part 4 is moving to and away the viewer.

The bearing points are shifted in the example of FIG. 3a asymmetrically in direction of a preload force by an angle of about 10 degrees (other angles are possible) in order to withstand the preload force. During the assembly process the balls will now be pushed into a special formed plastic ball cage (integrated ball cage) that will position itself automatically at the ball bearing contact point. The forces generated by the force F_{PRELOAD} will be absorbed by the bearing contact points which results into a system without backlash.

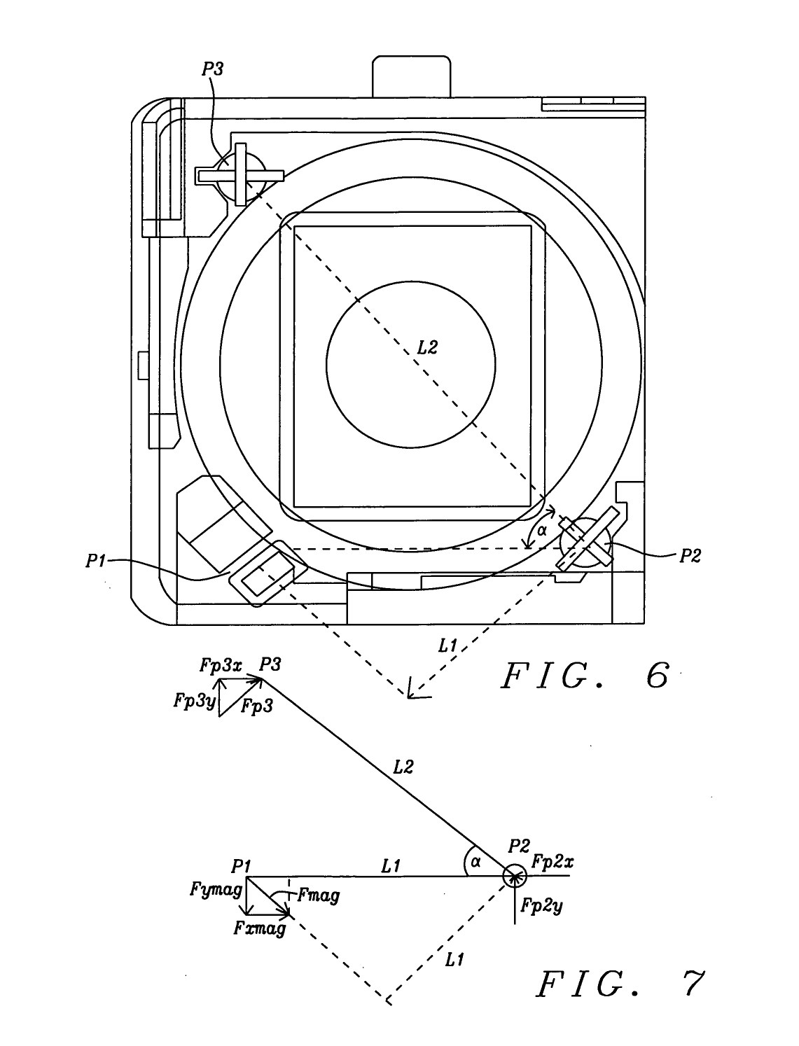

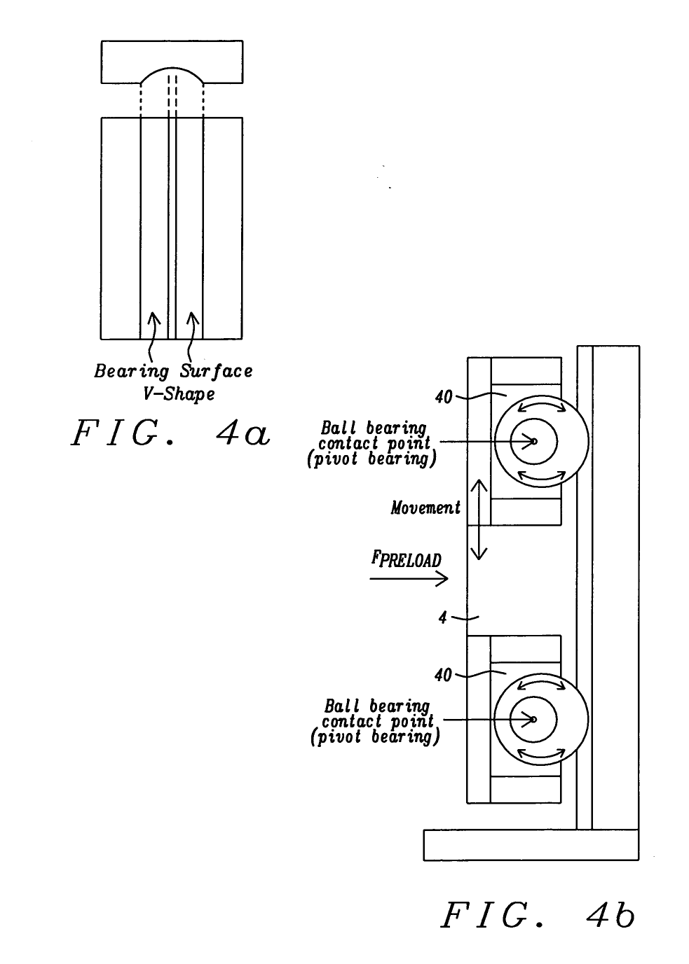

The fixed part of the actuator consist normally out of a fixed bearing and a non locating bearing as shown in FIG. 3b to achieve a statically defined bearing system. The surface of the fixed bearing is constructed out of a V-shape a shown in FIG. 4a, the non-locating bearing has a flat surface which will allow to absorb manufacturing tolerances.

The non-locating ball bearing shown in FIG. 3b consists in a preferred embodiment of two balls, a flat guiding surface, and an integrated ball cage for each ball that keep the distance of the two balls under all environmental conditions. The main purpose of this non-locating bearing is to compensate for any manufacturing tolerances of the parts. A magnetic preload guarantees the position and a continuous contact of the balls to the guiding surface.

In the preferred embodiment of the invention the balls have a diameter in the order of magnitude of 0.7 mm and the integrated ball cages are designed as such that the balls can not fall out in case the movement of the balls is <=150 μm.

FIG. 4b illustrates integrated ball cages 40 and two balls moving around their ball bearing contact points. Possible movements of the movable part 4 of the actuator are indicated by the double arrow. The balls are forced to rotate only in one possible rolling direction. The force F_{PRELOAD} will make sure that the balls have contacts to the bearing surfaces all the time to avoid backlash when changing the rolling direction.

The moving part of the actuator 4 will only move up or down vertically (in direction of the double arrow). The balls roll within the integrated ball cage as well as on the bearing surfaces as shown in FIG. 4a in the constraint direction.

FIG. 5 shows a preferred embodiment of a deployment of the non-locating bearing and of a fixed ball bearing applied to a camera module. It shows a magnetic arrangement 50 to provide a preload force as disclosed in the patent application DI10-005, titled “Single actuator configuration for a camera module”, Ser. No. 12/806,322, filing date Aug. 10, 2010. Furthermore FIG. 5 shoes a non-locating ball bearing 51 comprising 2 steel balls in a preferred embodiment. Moreover a fixed ball bearing 52 is shown comprising also 2 steel balls. Another number of balls or another ball material could be deployed also for the non-locating ball bearing 51 as well as for the fixed ball bearing 52. Furthermore the system defined lever 53 of the magnetically preloaded ball bearings having the angle α.

The non-locating ball bearing supports the following system requirements:
Take part of the attraction force generated by the permanent magnet of the actuator as load
Constrains motion of the two axes X and Y due to the preload
Elimination of part manufacturing tolerances (i.e. lens barrel, sensor carrier, ball diameter)

Alternatively it is possible to split the ball bearing positions: It is also possible to have the integrated ball cage integrated to the fixed part rather than the moving part (lens barrel).

FIG. 6 shows the main force vectors caused by the magnetic preload acting on both non-locating ball bearing and fixed ball bearing applied to the camera module.

FIG. 7 illustrates the different components of the main force vectors of FIG. 6. These components are used for the calculation of the resulting forces to keep the bearings together in case of a mechanical shock. P2 and P3 are the bearing points of the system. The attraction force F_{mag} generated by the magnetic preload at P1 will deliver forces to the ball bearings P2 and P3. The angle α between the line connecting P2 and P3 and the line connecting P1 and P2 is 45 degrees. Other angles α could be used as well. An angle α of 45 degrees is obviously the most appropriate setup but also other angular setups could be envisioned which would result in different force vectors. The connecting line between P2 and P3 is crossing the center of the lens barrel.

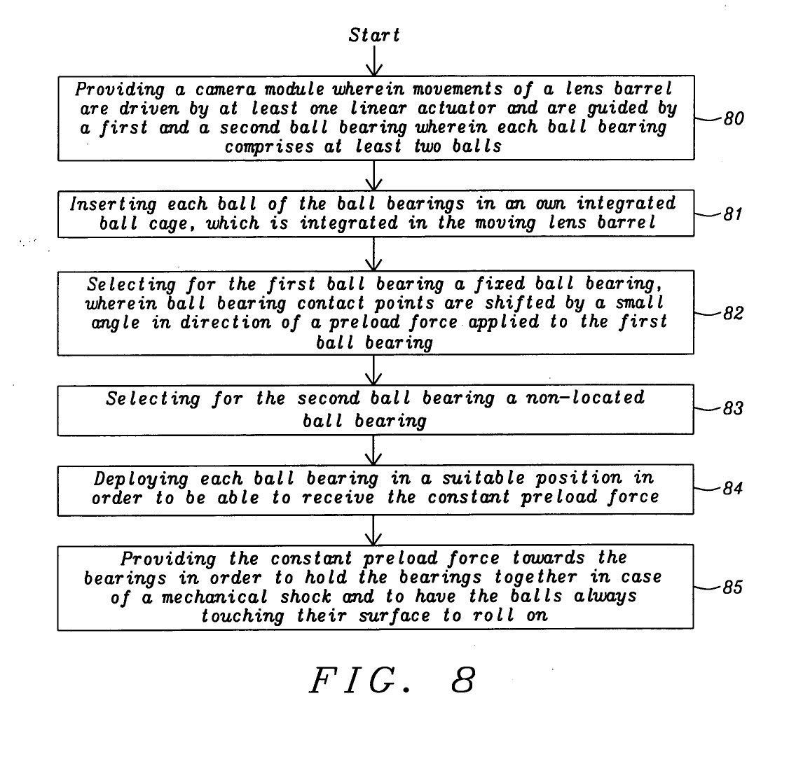

FIG. 8 illustrates a flowchart of a method invented to reduce manufacturing and assembly costs for measures to avoid blocking ball conditions for linear ball bearings.

Step 80 of the method of FIG. 8 illustrates the provision of a camera module wherein movements of a lens barrel are driven by at least one linear actuator and are guided by a first and a second ball bearing wherein each ball bearing comprises at least two balls. The invention could also be applied in case there is more than only one actuator involved, i.e. in a zoom module with more than one lens group to be moved. Furthermore the present invention can also be applied if other items than a lens barrel are to be moved as e.g. a camera shutter. Generally the invention can be applied to any linear movement if movements of the balls in just one rotational plane are required.

Step 81 describes inserting each ball of the ball bearings in an own integrated ball cage, which is integrated in the moving lens barrel. The ball cages can alternatively also be integrated in a fixed part of an actuator. Step 82 illustrates selecting for the first ball bearing a fixed ball bearing, wherein ball bearing contact points are shifted by a small angle in direction of a constant preload force applied to the first ball bearing. Step 83 depicts selecting for the second ball bearing a non-locating ball bearing. Step 84 illustrates deploying each ball bearing in a suitable position in order to be able to receive the constant preload force and step 85 depicts providing the constant preload force towards the bearings in order to hold the bearings together in case of a mechanical shock and to have the balls always touching their surface to roll on.

While the invention has been particularly shown and described with reference to the preferred embodiments thereof, it will be understood by those skilled in the art that various changes in form and details may be made without departing from the spirit and scope of the invention.

What is claimed is:

1. A method to reduce manufacturing and assembly costs for measures to avoid blocking ball conditions for linear ball bearings, comprising the following steps:
(1) providing a camera module wherein movements of a lens barrel are driven by at least one linear actuator and are guided by a first and a second ball bearing;
(2) inserting each ball of the ball bearings in an own integrated ball cage, which is integrated in the moving lens barrel;
(3) selecting for the first ball bearing a fixed ball bearing, wherein ball bearing contact points are shifted by a small angle in direction of a preload force applied to the first ball bearing;
(4) selecting for the second ball bearing a non-locating ball bearing;
(5) deploying each ball bearing in a suitable position in order to be able to receive the preload force; and
(6) providing the preload force towards the bearings in order to hold the bearings together in case of a mechanical shock and to have the balls always touching their surface to roll on.

2. The method of claim 1 wherein the ball bearings are used to guide any linear movement requiring ball rotations in only one rotational plane.

3. The method of claim 1 wherein the ball cages of both ball bearings are integrated in a fixed part of the camera module.

4. The method of claim 1 wherein a first ball cage is integrated in a fixed part of the camera module and a second ball cage is integrated in a moving part of the camera module.

5. The method of claim 1 wherein the integrated ball cages are made of plastic material.

6. The method of claim 1 wherein the balls of the ball bearings are inserted outside of a camera module housing.

7. The method of claim 1 wherein the contact points of the fixed ball bearings are shifted in the order of magnitude of about 10 degrees.

8. The method of claim 7 wherein the balls of the fixed ball bearings are pushed into a special formed plastic integrated ball cage, which will position itself automatically at the ball bearing contact point.

9. The method of claim 1 wherein the surface of the fixed ball bearing has a V-shape.

10. The method of claim 1 wherein the non-locating bearing has a flat surface.

11. The method of claim 1 wherein the fixed ball bearing and the non-locating ball bearing are deployed diagonally over the center of the lens barrel.

12. The method of claim 1 wherein a magnetic preload device, providing the preload force, is located in a way that it forms with the locations of both ball bearings an isosceles, right-angled triangle, wherein both distances between the location of the preload device to each ball bearing are equal.

13. The method of claim 1 wherein each ball bearing comprises two balls.

14. The method of claim 1 wherein each ball of both ball bearings is made of steel.

15. The method of claim 1 wherein said preload force is a constant preload force.

16. An arrangement of ball bearings preventing blocking and creeping of balls for guiding movements of a lens barrel comprises:
a fixed ball bearing, wherein ball bearing contact points are shifted by a small angle in direction of a constant preload force applied and each ball of the fixed ball bearing rolls in an own integrated ball cage, which is integrated in the moving lens barrel;
a non-locating ball bearing, wherein each ball of the non-locating ball bearing rolls in an own integrated ball cage, which is integrated in the moving lens barrel; and
a magnetic pre-load device providing a constant pre-load force on the fixed ball bearing and on the non-locating ball bearing in order to hold the bearings together in case of a mechanical shock and to have the balls always touching their surface to roll on.

17. The arrangement of ball bearings of claim 16 wherein said lens barrel is part of a camera module.

18. The arrangement of ball bearings of claim 16 wherein the ball cages of both ball bearings are integrated in a fixed part of the camera module.

19. The arrangement of ball bearings of claim 16 wherein the ball cages of both ball bearings are integrated in a moving part of the camera module.

20. The arrangement of ball bearings of claim 16 wherein a first ball cage is integrated in a fixed part of the camera module and a second ball cage is integrated in a moving part of the camera module.

21. The arrangement of ball bearings of claim 16 wherein the integrated ball cages are made of plastic material.

22. The arrangement of ball bearings of claim 16 wherein the balls of the ball bearings are inserted outside of a camera module housing.

23. The arrangement of ball bearings of claim 16 wherein the contact points of the fixed ball bearings are shifted in the order of magnitude of about 10 degrees.

24. The arrangement of ball bearings of claim 16 wherein the balls of the fixed ball bearings are pushed into a special formed plastic integrated ball cage, which will position itself automatically at the ball bearing contact point.

25. The arrangement of ball bearings of claim 16 wherein the surface of the fixed ball bearing has a V-shape.

26. The arrangement of ball bearings of claim 16 wherein the non-locating bearing has a flat surface.

27. The arrangement of ball bearings of claim 16 wherein the fixed ball bearing and the non-locating ball bearing are deployed diagonally over the center of the lens barrel.

28. The arrangement of ball bearings of claim 16 wherein the magnetic preload device is located in a way that it forms with the locations of both ball bearings an isosceles, right-angled triangle, wherein both distances between the location of the preload device to each ball bearing are equal and wherein a line connecting both ball bearings crosses the center of the lens barrel.

29. The arrangement of ball bearings of claim 16 wherein each ball bearing comprises two balls.

30. The arrangement of ball bearings of claim 16 wherein each ball of both ball bearings is made of steel.
